(19) United States
(12) Patent Application Publication
(10) Pub. No.: US 2026/0098147 A1
(43) Pub. Date: Apr. 9, 2026

(54) POLYMER BLEND FOR THE PRODUCTION OF A BIORIENTED POLYMER FILM

(71) Applicant: Basell Polyolefine GmbH, Wesseling (DE)

(72) Inventors: Gianni Perdomi, Ferrara (IT); Morica Galvan, Ferrara (IT)

(73) Assignee: Basell Polyolefine GmbH, Wesseling (DE)

(21) Appl. No.: 19/116,081

(22) PCT Filed: Sep. 29, 2023
(86) PCT No.: PCT/EP2023/077026

§ 371 Date: Mar. 27, 2025

(30) Foreign Application Priority Data
Sep. 30, 2022 (EP) 22198985.8

(51) Int. Cl. C08L 23/06; B29C 55/14; C08J 5/18

(52) U.S. Cl. CPC C08L 23/06; C08J 5/18; B29C 55/14; B29K 2023/06; B29K 2995/0053; C08J 2323/06; C08J 2423/06; C08L 2203/16; C08L 2205/025

(57) ABSTRACT

A polymer blend made from or containing:
A) from 65 to 98 wt. % of a first polyethylene component, having a density from 0.948 to 0.960 g/cm³, a Melt Index MIF from 30 to 100 g/10 min, and a Melt Flow Ratio MIF/MIP from 15 to 30; and
B) from 2 to 35 wt. % of a second polyethylene component, having a density from 0.910 to 0.945 g/cm³ and a Melt Index MIE of 0.1 to 3 g/10 min.

### FIELD OF THE INVENTION

In general, the present disclosure relates to the field of chemistry. More specifically, the present disclosure relates to polymer chemistry. In particular, the present disclosure relates to a polymer blend, a method for producing a bioriented polymer film from the polymer blend, and the resulting bioriented polymer film.

### BACKGROUND OF THE INVENTION

In some instances, polymeric films are used in industrial manufacturing processes and in the nonindustrial sector for the wholesale and retail delivery of goods to the consumer market.

In some instances, films made from or containing ethylene based thermoplastic polymers are used in household disposables, trash bags and liners; overwrap films and bags for laundry and dry cleaning goods; and shipping and carryout bags for retail merchandising of non-perishable goods. In some instances, ethylene based polymer films compete weakly with plasticized polyvinyl chloride films, polypropylene films, or both in the heat-shrink wrap film market. In some instances, heat-shrink wrap film is used for the taut-contour fit wrapping of various items. In some instances, the items include perishables such as cuts of meat, poultry, and fish. In some instances, ethylene based polymer films compete for packaging of produce as well as package constructions for cereals, dry foods, and snack foods.

In some instances and for mechanical and optical properties, bi-oriented polymeric films are increasingly requested for packaging applications.

In some instances and to achieve a certain profile of properties, bioriented polymeric films have a multiple layer structure, with layers of different polymeric materials. In some instances, the polymeric materials are selected from the group consisting of polypropylene, polyethylene, polyethylene terephthalate, polyamides, and ethylene polyvinyl alcohol.

In some instances, these structures are complex and involve complex processing. In some instances, these structures face challenges with achieving sustainability and recyclability goals.

### SUMMARY OF THE INVENTION

In a general embodiment, the present disclosure provides a polymer blend made from or containing:
A) from 65 to 98 wt. % of a first polyethylene component, having a density from 0.948 to 0.960 g/cm³, a Melt Index MIF from 30 to 100 g/10 min, and a Melt Flow Ratio MIF/MIP from 15 to 30, alternatively up to 25; and
B) from 2 to 35 wt. % of a second polyethylene component, having a density from 0.910 to 0.945 g/cm³ and a Melt Index MIE from 0.1 to 3 g/10 min.

In some embodiments, the above wt. % of the first polyethylene component and of second polyethylene component are with respect to the overall weight (that is, the sum of weights) of the first polyethylene component and of second polyethylene component. In some embodiments, the above wt. % of the first polyethylene component and of second polyethylene component are with respect to the overall weight of the polymer blend.

### DETAILED DESCRIPTION OF THE INVENTION

As used herein, the term “MIF” refers to the Melt Index measured with 21.6 kg at 190° C. As used herein, the term “MIP” refers to the Melt Index measured with 5 kg at 190° C. As used herein, the term “MIE” refers to the Melt Index measured with 2.16 kg at 190° C.

In some embodiments, the first polyethylene component A) and the second polyethylene component B) are selected from the group consisting of ethylene homopolymers, ethylene copolymers containing alpha-olefin monomer units, and mixtures thereof. In some embodiments, the ethylene copolymers have the alpha-olefin monomer units present in amounts of up to 10% by weight. In some embodiments, the alpha-olefin monomer units have from 3 to 8 carbon atoms. In some embodiments, the alpha-olefin monomer units are selected from the group consisting of propylene, 1-butene, 1-pentene, 1-hexene, 1-octene and 4-methyl-1-pentene. In some embodiments, the alpha-olefin monomer units are selected from the group consisting of 1-butene and 1-hexene.

In some embodiments, the homopolymers and copolymers are obtained by polymerization processes in the presence of coordination catalysts.

In some embodiments, the polymerization process is carried out in the presence of a Ziegler-Natta catalyst or a single site catalyst.

In some embodiments, the Ziegler-Natta catalyst is made from or containing the product of the reaction of an organometallic compound of group 1, 2 or 13 of the Periodic Table of elements with a transition metal compound of groups 4 to 10 of the Periodic Table of Elements (new notation). In some embodiments, the transition metal compound is selected from the group consisting of compounds of Ti, V, Zr, Cr and Hf. In some embodiments, the transition metal compound is supported on MgCl₂.

In some embodiments, the catalysts are made from or containing the product of the reaction of the organometallic compound of group 1, 2 or 13 of the Periodic Table of elements, with a solid catalyst component made from or containing a Ti compound supported on MgCl₂.

In some embodiments, the organometallic compounds are organo-Al compounds.

In some embodiments, the single site catalysts are selected from the group consisting of metallocene and non-metallocene single site catalysts.

In some embodiments, the metallocene single site catalysts are selected from the group consisting of zirconocenes and hafnocenes. In some embodiments, the metallocene single site catalysts are selected from the group consisting of cyclopentadienyl or indenyl complexes of zirconium or hafnium. In some embodiments, the metallocene single site catalysts are selected from the group consisting of bis(cyclopentadienyl) zirconium dichloride, bis(indenyl) zirconium dichloride, and bis(indenyl) hafnium dichloride.

In some embodiments, the non-metallocene single site catalysts are iron complex compounds. In some embodiments, the non-metallocene single site catalysts are iron complex compounds have a tridentate ligand.

In some embodiments, the tridentate ligands are 2,6-Bis [1-(phenylimino)ethyl]pyridine. In some embodiments, the tridentate ligands are the corresponding compounds, wherein both the two phenyl groups are substituted in the ortho-position with a halogen or tert. alkyl substituent.

In some embodiments, the tridentate ligand is 2,6-Bis [1-(2-tert.butylphenylimino)ethyl|pyridine iron(II) dichloride. In some embodiments, the tridentate ligands are selected from the group consisting of 2,6-Bis [1-(2-tert.butyl-6-chlorophenylimino)ethyl|pyridine iron(II) dichloride and 2,6-Bis [1-(2,4-dichlorophenylimino)ethyl|pyridine iron(II) dichloride.

In some embodiments, the metallocene and non-metallocene single site catalysts are used in combination.

In some embodiments, the single site catalysts are reacted with activating compounds (co-catalysts). In some embodiments, the co-catalysts are aluminoxanes. In some embodiments, the co-catalyst is mono-methylaluminoxane (MAO).

In some embodiments, the polymerization is continuous or batch. In some embodiments, the polymerization is carried out in the presence of the catalysts and operating in liquid phase, in the presence or the absence of inert diluent. In some embodiments, the polymerization is carried out in the presence of the catalysts and operating in gas phase or by mixed liquid-gas techniques.

In some embodiments, the polymerization temperature is in the range of from 50 to 100° C. In some embodiments, the polymerization pressure is atmospheric or higher.

In some embodiments, the regulation of the molecular weight is carried out by using molecular weight regulators. In some embodiments, the molecular weight regulator is hydrogen.

In some embodiments, the second polyethylene component B) is made from or containing a low density polyethylene (LDPE). In some embodiments, the low density polyethylene is selected from the group consisting of ethylene homopolymers and copolymers produced in a high pressure free radical polymerization.

In some embodiments, the LDPE copolymers are selected from the group consisting of ethylene-vinyl acetate copolymers, ethylene-vinyl alcohol copolymers, ethylene-acrylate copolymers, ethylene-methacrylate copolymers, ethylene copolymers containing alpha-olefin monomer units and mixtures thereof.

In some embodiments, the alpha-olefin monomer units in the LDPE copolymers are as previously described herein.

In some embodiments, the high pressure polymerization reactor processes for the manufacture of LDPE are selected from the group consisting of autoclave and tubular.

In some embodiments, the LDPE made by the autoclave reactor process has a high concentration of long chain branches, thereby resulting in high values of elongational hardening, and a relatively broad molecular weight distribution, thereby minimizing challenges of processing of the LDPE.

In some embodiments, the autoclave polymerization is carried out in the presence of radical initiating agents selected from organic peroxides.

In some embodiments, the tubular reactor process occurs in the absence of organic peroxides. In some embodiments, the tubular reactor process is carried out by using oxygen as the radical initiating agent, thereby preparing a LDPE free from the products of chemical degradation of organic peroxides.

In some embodiments, the LDPE is prepared with a mixed process combining both autoclave and tubular reactors.

In some embodiments, the process operating pressure is in the range of from 70 MPa to 700 MPa. In some embodiments, the process operating temperature is in the range of from 150° C. to 500° C.

In some embodiments, the polymerization is carried out in the presence of one or more chain transfer agents. In some embodiments, the chain transfer agents are selected from the group consisting of propylene, propane and propionic aldehyde.

In some embodiments, the chain transfer agents regulate the molecular weights.

In some embodiments, the tubular reactor process for preparing the LDPE is as described in U.S. Pat. No. 3,691,145 or United States Patent Application No. 2010/0076160.

As used herein, the term “copolymer” also refers to polymers containing more than a single kind of comonomers, such as terpolymers.

In some embodiments, the ethylene homopolymers and copolymers are commercially available.

In some embodiments, the first polyethylene component has a tensile modulus of at least 650 MPa, alternatively at least 800 MPa, alternatively at least 850 MPa. In some embodiments, the first polyethylene component has a tensile modulus of up to 1300 MPa, alternatively up to 1200 MPa, alternatively up to 1100 MPa.

In some embodiments, the second polyethylene component has tensile modulus up to 1000 MPa, alternatively up to 800 MPa. In some embodiments, the second polyethylene component has tensile modulus up to 400 MPa, alternatively up to 300 MPa.

In some embodiments, the second polyethylene component has tensile modulus of at least 100 MPa, alternatively at least 200 MPa, alternatively at least 250 MPa.

In some embodiments, the second polyethylene component has a mass-average molar mass Mw lower than 170000 g/mol, alternatively lower than 160000 g/mol.

In some embodiments, the second polyethylene component has a Mw lower than 130000 g/mol, alternatively lower than 120000 g/mol.

In some embodiments, the second polyethylene component has a Mw higher than 90000 g/mol, alternatively higher than 100000 g/mol.

In some embodiments, the second polyethylene component has a dispersity Mw/Mn lower than 22.0, alternatively lower than 17.0.

In some embodiments, the second polyethylene component has a Mw/Mn lower than 10.0, alternatively lower than 8.0.

In some embodiments, the second polyethylene component has a Mw/Mn higher than 5.0, alternatively higher than 6.0.

In some embodiments, the second polyethylene component has a number-average molar mass Mn higher than 9000 g/mol, alternatively higher than 13000 g/mol. In some embodiments, the second polyethylene component has a number-average molar mass Mn lower than 20000 g/mol, alternatively lower than 17000 g/mol.

In some embodiments, the second polyethylene component has a number-average molar mass Mz lower than 800000 g/mol, alternatively lower than 400000 g/mol. In some embodiments, the second polyethylene component has a number-average molar mass Mz higher than 200000 g/mol, alternatively higher than 250000 g/mol.

In some embodiments, the first polyethylene component has a mass-average molar mass Mw higher than 175000 g/mol, alternatively higher than 185000 g/mol.

In some embodiments, the first polyethylene component has a Mw lower than 250000 g/mol, alternatively lower than 210000 g/mol.

In some embodiments, the first polyethylene component has a dispersity Mw/Mn higher than 22.0, alternatively higher than 25.0, alternatively higher than 26.0.

In some embodiments, the first polyethylene component has a Mw/Mn lower than 34, alternatively lower than 30.

In some embodiments, the first polyethylene component has a number-average molar mass Mz higher than 800000 g/mol, alternatively higher than 900000 g/mol. In some embodiments, the first polyethylene component has a number-average molar mass Mz lower than 150000 g/mol, alternatively lower than 120000 g/mol.

In some embodiments, the first polyethylene component has a number-average molar mass Mn lower than 9000 g/mol, alternatively lower than 8000 g/mol. In some embodiments, the first polyethylene component has a number-average molar mass Mn higher than 4000 g/mol, alternatively higher than 6000 g/mol.

In some embodiments, the first polyethylene component has a density of at least 0.950 g/cm³. In some embodiments, the second polyethylene component has a density up to 0.940 g/cm³, alternatively up to 0.930 g/cm³. In some embodiments, the first polyethylene component has a density of at least 0.950 g/cm³ and the second polyethylene component has a density up to 0.940 g/cm³, alternatively up to 0.930 g/cm³. In some embodiments, the second polyethylene component has a density of at least 0.915 g/cm³. In some embodiments, the second polyethylene component has a density of 0.915 g/cm³ to 0.940 g/cm³.

In some embodiments, the first polyethylene component has a Melt Index MIF from 45 to 80 g/10 min. In some embodiments, the second polyethylene component has a Melt Index MIE from 0.6 to 2 g/10 min. In some embodiments, the first polyethylene component has a Melt Index MIF from 45 to 80 g/10 min and the second polyethylene component has a Melt Index MIE from 0.6 to 2 g/10 min.

In some embodiments, the polymer blend is made from or containing from 67 to 95 wt. % of the first polyethylene component, with respect to the overall weight (that is, the sum of weights) of the first polyethylene component and of second polyethylene component. In some embodiments, the polymer blend is made from or containing up to 33 wt. %, alternatively up to 25 wt. %, alternatively up to 15 wt. %, of the second polyethylene component, with respect to the overall weight (that is, the sum of weights) of the first polyethylene component and of second polyethylene component. In some embodiments, the polymer blend is made from or containing at least 5 wt. %, alternatively at least 10 wt. %, of the second polyethylene component, with respect to the overall weight (that is, the sum of weights) of the first polyethylene component and of second polyethylene component. In some embodiments, the polymer blend is made from or containing at least 5 wt. % up to 15 wt. % of the second polyethylene component, with respect to the overall weight (that is, the sum of weights) of the first polyethylene component and of second polyethylene component.

In some embodiments, the first polyethylene component has a Melt Index MIP from 0.5 g/10 min, alternatively from 1.0 g/10 min, to 15 g/10 min, alternatively to 10 g/10 min. In some embodiments, the first polyethylene component has a Melt Index MIP from 1.0 to 10 g/10 min.

In some embodiments, the polymer blend is made from or containing:
from 65 to 98 wt. % of the first polyethylene component;
from 2 to 33 wt. % of the second polyethylene component, having a tensile modulus of up to 350 MPa, alternatively up to 300 MPa; and
from 1 wt. %, alternatively from 2 wt. %, up to 33 wt. %, alternatively up to 20 wt. %, of a third polyethylene component, having a density from 0.920 to 0.950 g/cm³, a Melt Index MIE from 0.1 to 3 g/10 min, and a tensile modulus of at least 400 MPa, alternatively at least 500 MPa, with the wt. % being with respect to the overall weight (that is, the sum of weights) of the first polyethylene component, the second polyethylene component, and the third polyethylene component.

In some embodiments, the sum of the weights of the second polyethylene component and of the third polyethylene component is from 3 wt. %, alternatively from 5 wt. %, to 35 wt. %, alternatively to 33 wt. %, with respect to the overall weight (that is, the sum of weights) of the first polyethylene component, the second polyethylene component, and the third polyethylene component.

In some embodiments, the third polyethylene component has a density from 0.920 to 0.950 g/cm³, a Melt Index MIE of 0.1 to 3 g/10 min, and a Mw lower than 170000 g/mol, alternatively lower than 160000, and higher than 135000, alternatively higher than 145000, alternatively higher than 150000. In some embodiments, the third polyethylene component has a Mw/Mn lower than 25, alternatively lower than 22, and higher than 11, alternatively higher than 12.

In some embodiments, the second polyethylene component has a Mw lower than 130000 g/mol, alternatively lower than 120000 g/mol.

In some embodiments, the wt. % of the second polyethylene component is equal or higher than the wt. % of the third polyethylene component (the wt. % of the third polyethylene component and of the second polyethylene component being with respect to the overall weight—that is, the sum of weights—of the first polyethylene component, of second polyethylene component and of third polyethylene component).

In some embodiments, the polymer blend is made from or containing from 2 wt. % to 25 wt. %, alternatively to 20 wt. %, alternatively to 15 wt. %, of the second polyethylene component, with respect to the overall weight (that is, the sum of weights) of the first polyethylene component, the second polyethylene component, and the third polyethylene component.

In some embodiments, the polymer blend is made from or containing from 2 wt. % to 25, alternatively to 20 wt. %, alternatively to 15 wt. %, of the third polyethylene component, with respect to the overall weight (that is, the sum of weights) of the first polyethylene component, the second polyethylene component, and the third polyethylene component.

In some embodiments, the polymer blend consists of the first polyethylene component and the second polyethylene component. In some embodiments, the polymer blend consists of the first polyethylene component, the second polyethylene component, and the third polyethylene component.

In some embodiments, the polymer blend is further made from or containing additives.

In some embodiments, the additives are selected from the group consisting of heat stabilizers, antioxidants, UV absorbers, light stabilizers, metal deactivators, compounds which destroy peroxide, and costabilizers. In some embodiments, the additives are present in amounts of from 0.01 to 10% by weight, alternatively from 0.1 to 5% by weight, with respect to the total weight of the polymer blend.

In some embodiments, the present disclosure provides a process for the production of the polymer blend. In some embodiments, the process includes a combination step, during which the first polyethylene component and the second polyethylene component (and, optionally, the third polyethylene component) are combined by melting and mixing the components. In some embodiments, the mixing is effected in a mixing apparatus at temperatures of from 160 to 250° C.

In some embodiments, the melt-mixing apparatus is selected from the group consisting of extruders and kneaders. In some embodiments, the melt-mixing apparatus is a twin-screw extruder. In some embodiments, the components are premixed at room temperature in a mixing apparatus.

In some embodiments, the present disclosure provides a process for producing a bioriented polymer film made from or containing the polymer blend.

In some embodiments, the process for producing a bioriented polymer film includes a stretching step, during which a film of the polymer blend is stretched in a first and a second direction crosswise, alternatively perpendicular, to each other.

In some embodiments, the film of the polymer blend is stretched in the first direction with a stretch ratio from 3:1 to 9:1. In some embodiments, the film of the polymer blend is stretched in the second direction with a stretch ratio from 3:1 to 7:1.

In some embodiments, the primary film before stretching has a thickness of at least 0.3 mm, alternatively at least 0.5 mm. In some embodiments, the bioriented polymer film has a thickness of less than 250 μm, alternatively less than 100 μm, alternatively less than 50 μm.

In some embodiments, the present disclosure provides a method for producing a bioriented polymer film including the stretching step. In some embodiments, the present disclosure provides the bioriented polymer film.

In some embodiments, the bioriented polymer films are mono or multilayer bioriented films.

In some embodiments, the bioriented polymer films are prepared using a tenter frame process. In some embodiments and in a tenter frame process, the polymer is extruded as a film directly onto a chilled roller and the film is then passed through a stretching unit by rollers moving faster than the rate at which the polymer is extruded. In some embodiments, this process orients the film in the machine direction (MD).

In some embodiments, the film extrusion is carried out at operating temperatures in the range of from 180 to 300° C.

In some embodiments, an orientation stage is carried out in the stretching unit, with the operating conditions including:
Pre-heating temperature: 120-130° C.;
Pre-heating time: 60-100 sec.;
Stretch rate: 40-80%/sec.; and
Stretch ratio: 3:1-9:1.

In some embodiments, the film is then fed into a tenter frame for transverse direction orientation. In some embodiments and in the tenter frame, the film is maintained at the pre-heating temperature and gripped along each edge by clamps that are attached to moving chains. In some embodiments, the clamps move outwards to stretch the film in the transverse direction (TD). In some embodiments and after stretching, the film is heat-set to hold the orientation and then reeled up.

In some embodiments and at this stage, the operating conditions include:
Stretch rate: 30-60%/sec.; and
Stretch ratio: 3:1-7:1.

In some embodiments, the bioriented films are produced using a twin-bubble method. In some embodiments, the twin-bubble method involves producing a primary tubular film with concentric layers (when the film is multilayer) by extrusion of the polymer components constituting the various layers through an annular slot. In some embodiments, the primary film is calibrated and rapidly cooled and then heated and oriented in the machine and transverse direction by blowing with compressed air (TD) and increasing the speed of the take-up roll (MD). In some embodiments, the bioriented film is then rapidly cooled, thereby stabilizing the molecular orientation of the film.

In some embodiments, heating is carried out by IR lamps, hot air, or other heating elements, like electrical resistance heaters.

In some embodiments, biaxial films are used for heat-shrinking applications.

In some embodiments, the method for producing the bioriented films is as described in Patent Cooperation Treaty Publication No. WO97/22470.

In some embodiments, the present disclosure provides a bioriented polymer film consisting of a polymer blend.

In some embodiments, the bioriented polymer film has a thickness of less than 250 μm, alternatively less than 100 μm, alternatively less than 50 μm.

In some embodiments, the bioriented polymer film has one or more of the following properties:
Haze from 1.5 to 20%, alternatively from 1.5 to 6.5; or
Gloss on film (at 45° C.): from 45 to 100 GU; or
Tensile Modulus MD: from 700 to 1600 MPa; or
Tensile Modulus TD: from 800 to 1800 MPa; or
Strength at break MD: from 60 to 200 MPa; or
Strength at break TD: from 130 to 250 MPa; or
Elongation at break MD: from 40 to 200%; or
Elongation at break TD: from 40 to 200%.

### EXAMPLES

The following examples are illustrative and not intended to limit the scope of the disclosure.

The following analytical methods are used to characterize the polymer compositions.

### Melt Flow Index

Determined according to ISO 1133-1 2012-03 at 190° C. with the specified load.

### Density

Determined according to ISO 1183-1:2012 at 23° C., immersion method.

### Tensile Modulus

Determined according to ASTM D882-18.

### Gloss

Determined according to ASTM D-2457-13.

### Haze

Determined according to ASTM D-1003-13.

### Molecular Weight Distribution Determination

The determination of the means Mw, Mn and Mz and of Mw/Mn derived therefrom was carried out by high-temperature gel permeation chromatography using a method described in ISO 16014-1,-2,-4, issue of 2003. The specifics according to the mentioned ISO standards were as follows: Solvent 1,2,4-trichlorobenzene (TCB), temperature of apparatus and solutions 145° C. and, as concentration detector, a PolymerChar (Valencia, Paterna 46980, Spain) IR-4 infrared detector, for use with TCB. A WATERS Alliance 2000 equipped with pre-column SHODEX UT-G and separation columns SHODEX UT 806 M (3×) and SHODEX UT 807 (Showa Denko Europe GmbH, Konrad-Zuse-Platz 4, 81829 Muenchen, Germany) connected in series was used.

The solvent was vacuum distilled under Nitrogen and stabilized with 0.025% by weight of 2,6-di-tert-butyl-4-methylphenol. The flowrate used was 1 ml/min. The injection was 500 μl. The polymer concentration was in the range of 0.01%<conc.<0.05% w/w. The molecular weight calibration was established by using monodisperse polystyrene (PS) standards from Polymer Laboratories (now Agilent Technologies, Herrenberger Str. 130, 71034 Boeblingen, Germany) in the range from 580 g/mol up to 11600000 g/mol and additionally with Hexadecane.

The calibration curve was then adapted to Polyethylene (PE) by the Universal Calibration method (Benoit H., Rempp P. and Grubisic Z., & in J. Polymer Sci., Phys. Ed., 5, 753 (1967)). The Mark-Houwing parameters used were for PS: k_{PS}=0.000121 dl/g, α_{PS}=0.706 and for PE k_{PE}=0.000406 dl/g, αPE=0.725, valid in TCB at 135° C. Data recording, calibration and calculation were carried out using NTGPC_Control_V6.02.03 and NTGPC_V6.4.24 (hs GmbH, Hauptstraβe 36, D-55437 Ober-Hilbersheim, Germany) respectively.

### Comonomer Content

The comonomer content was determined by IR in accordance with ASTM D 6248 98, using an FT-IR spectrometer Tensor 27 from Bruker, calibrated with a chemometric model for determining ethyl-side-chains in PE for butene-1 as comonomer and butyl-side-chains in PE for hexene-1 as comonomer.

### Example 1

This example discloses the production of samples of bioriented polymer films and the characteristics of the resulting films.

The following starting polyethylene materials were commercially available from LyondellBasell Industries.

### Hostalen GD 9555 (GD9555)

MIP: 3.0 g/10 min;
MIF: 63 g/10 min;
Density: 0.953 g/cm³;
Tensile modulus: 1050 MPa;
Tensile Stress at Yield: 25 MPa;
Tensile Strain at Yield: 10%.
   Luflexen hyPE 35P FA (hyPE)
MIE: 0.75 g/10 min;
Density: 0.936 g/cm³;
Tensile modulus: 600 MPa;
Tensile Stress at Yield: 16 MPa.

### Lupolen 2420F (LP 2420F)

MIE: 0.75 g/10 min;
Density: 0.923 g/cm³;
Tensile modulus: 260 MPa;
Tensile Stress at Yield: 11 MPa.

The molecular weights are reported in Table 1 below.

TABLE 1

| | GD 9555 | hyPE 35PFA | LP 2420F |
|---|---|---|---|
| Mn [g/mol] | 7116 | 11161 | 15288 |
| Mw [g/mol] | 195382 | 155288 | 110236 |
| Mw/Mn | 27.46 | 13.91 | 7.21 |
| Mz [g/mol] | 1078110 | 519473 | 318406 |

Samples of bioriented polymer films with the following polymer blends were produced (the percentages are by weight with respect to the overall weight of the polymer blend).
A: 100% GD9555
B: 90% GD9555+10% hyPE
C: 90% GD9555+10% LP 2420F
D: 80% GD9555+10% hyPE+10% LP 2420F
E: 70% GD9555+15% hyPE+15% LP 2420F

To obtain the bioriented polymer films, the following procedure was used.

A primary film, having a thickness of 1 mm, was prepared using a Leonard line with the following features and under the following conditions:
Extruder diameter: 40 mm, L/D 27;
Dosing gear pump;

Flat die, with lip width 200 mm, die lip gap of 1 mm;
Melt temperature: 240° C.;
3 chill rolls having a diameter of 160 mm, with roll temperature of 45° C.;
Film cutting unit.

From the primary film, 93×93 mm specimens were cut. The specimens were then oriented using a Brueckner KARO IV stretching unit, under the following conditions:
Pre-heating temperature: 123° C.;
heating time: 80 sec;
stretching speed: 45-60%/see;
stretching area: 70×70 mm (out of clamps);
stretch ratio: MD 6:1; TD 5:1; and
final thickness: 23 μm.

The bioriented polymer films had the characteristics indicated in Table 2 below.

TABLE 2

| Characteristic | units | A | B | C | D | E |
|---|---|---|---|---|---|---|
| Haze on film | % | 6.8 | 6.2 | 5.2 | 4.0 | 3.6 |
| Gloss on film (at 45° C.) | GU | 68.5 | 80.4 | 79.2 | 81.7 | 82.3 |
| Tensile Modulus MD | MPa | 1026 | 1205 | 1367 | 1112 | 1020 |
| Tensile Modulus TD | MPa | 1460 | 1640 | 1713 | 1467 | 1410 |
| Strength at break MD | MPa | 128 | 164 | 168 | 158 | 144 |
| Elongation at break MD | % | 83 | 105 | 90 | 84 | 89 |
| Strength at break TD | MPa | 147 | 181 | 197 | 190 | 173 |
| Elongation at break TD | % | 60 | 60 | 86 | 80 | 70 |

As used herein, MD refers to in the “machine direction”. In other words, MD indicates that the measurement was carried out the direction of the extrusion.

As used herein, TD refers to in the “Transversal direction”. In other words, TD indicates that the measurement was carried out in a direction perpendicular to the direction of the extrusion.

What is claimed is:

1. A polymer blend comprising:
A) from 65 to 98 wt. % of a first polyethylene component, having a density from 0.948 to 0.960 g/cm³, a Melt Index MIF from 30 to 100 g/10 min, and a Melt Flow Ratio MIF/MIP from 15 to 30; and
B) from 2 to 35 wt. % of a second polyethylene component, having a density from 0.910 to 0.945 g/cm³ and a Melt Index MIE from 0.1 to 3 g/10 min,
the wt. % of the first polyethylene component and of second polyethylene component being with respect to the overall weight of the first polyethylene component and of second polyethylene component.

2. The polymer blend according to claim 1, wherein the first polyethylene component has a tensile modulus of at least 650 MPa.

3. The polymer blend according to claim 1, wherein the second polyethylene component has a tensile modulus of at least 100 MPa.

4. The polymer blend according to claim 1, wherein
(i) the first polyethylene component has a Mw higher than 175000 g/mol and a Mw/Mn higher than 22 and
(ii) the second polyethylene component has a Mw lower than 170000 g/mol and a Mw/Mn lower than 22.

5. The polymer blend according to claim 1, wherein
(i) the first polyethylene component has a density of at least 0.950 g/cm³; and
(ii) the second polyethylene component has a density of 0.915 to 0.940 g/cm³.

6. The polymer blend according to claim 1, wherein
(i) the first polyethylene component has a Melt Index MIF of 45 to 80 g/10 min and
(ii) the second polyethylene component having a Melt Index MIE of 0.6 to 2 g/10 min.

7. The polymer blend according to claim 1, comprising
A) from 67 to 95 wt. % of the first polyethylene component, having a Melt Index MIP of 0.5 to 15 g/10 min; and
B) from 5% to 33% wt. % of the second polyethylene component,
the wt. % of the first polyethylene component and of second polyethylene component being with respect to the overall weight of the first polyethylene component and of second polyethylene component.

8. The polymer blend according to claim 1, comprising:
from 65 to 98 wt. % of the first polyethylene component;
from 2 to 33 wt. % of the second polyethylene component, having a tensile modulus of up to 350 MPa; and
from 1 to 33 wt. % of a third polyethylene component, having a density from 0.920 to 0.950 g/cm³, a Melt Index MIE of 0.1 to 3 g/10 min, and a tensile modulus of at least 400 MPa;
with the wt. % being with respect to the overall weight of the first polyethylene component, of the second polyethylene component, and the third polyethylene component.

9. The polymer blend according to claim 1, comprising:
from 65 to 98 wt. % of the first polyethylene component;
from 2 to 33 wt. % of the second polyethylene component, having a Mw lower than 130000 g/mol and a Mw/Mn lower than 10;
from 1 to 33 wt. % of a third polyethylene component, having a density from 0.920 to 0.950 g/cm³, a Melt Index MIE of 0.1 to 3 g/10 min, a Mw lower than 170000 g/mol and higher than 135000, and a Mw/Mn lower than 22 and higher than 11;
wherein the wt. % being with respect to the overall weight of the first polyethylene component, the second polyethylene component, and the third polyethylene component and
the sum of the weights of the second polyethylene component and the third polyethylene component is from 3 to 35 wt. %, with respect to the overall weight of the first polyethylene component, the second polyethylene component, and the third polyethylene component.

10. The polymer blend according to claim 8, wherein the wt. % of the second polyethylene component is equal or higher than the wt. % of the third polyethylene component; and the wt. % of the third polyethylene component and of the second polyethylene component being with respect to the overall weight of the first polyethylene component, the second polyethylene component and the third polyethylene component.

11. (canceled)

12. (canceled)

13. A process for producing a bioriented polymer film comprising:
a stretching step, during which a primary film of the polymer blend according to claim 1 is stretched in a first direction and a second direction crosswise to each other, thereby providing the bioriented polymer film.

14. The method according to claim 13, wherein the primary film has a thickness of at least 0.3 mm, and the bioriented polymer film has a thickness of less than 250 μm.

15. A bioriented polymer film comprising a polymer blend according to claim 1.

16. The bioriented polymer film according to claim 15, having a thickness of less than 250 μm.
